(19) United States
(12) Patent Application Publication
(10) Pub. No.: US 2008/0319810 A1
(43) Pub. Date: Dec. 25, 2008

(54) METHODS AND SYSTEM FOR COLLECTING, STORING AND DISTRIBUTING INFORMATION RELATING TO GOODS AND/OR SERVICES

(76) Inventor: Robert Stewart Mostyn, Hemel Hempstead (GB)

Correspondence Address: LACKENBACH SIEGEL, LLP, LACKENBACH SIEGEL BUILDING, 1 CHASE ROAD, SCARSDALE, NY, 10583, US

(21) Appl. No.: 11/766,215

(22) Filed: Jun. 21, 2007

(51) Int. Cl. G06F 17/50

(52) U.S. Cl. 705/7

(57) ABSTRACT

Presented are methods and systems for collecting, storing and distributing information relating to goods and/or services, and in particular, information relating to the environmental impact of goods and/or services at respective points in a lifecycle of the good and/or service.

### FIELD OF THE INVENTION

This application relates to methods and a system for collecting, storing and distributing information relating to goods and/or services, and in particular, although not exclusively, is concerned with information relating to the environmental impact of goods and/or services.

### BACKGROUND OF THE INVENTION

It is generally accepted that there is a need to reduce the environmental impact of goods and/or services. This is due to the perception that the uncontrolled exploitation of the natural resources available on this planet together with a lack of concern for the disposal of unwanted materials or waste products is harming the environment.

For instance, at present there is little legislation in the world to persuade a consumer to limit their use of goods and/or services other than by the price of those goods and/or services. Although some legislation is present in certain countries which ensures that some information is available to the consumer, for instance regarding emissions from cars, a consumer at present is mostly unable to ascertain the environmental impact of a particular good or service or be able to compare that with the environmental impact of another equivalent good or service. Furthermore, even though limited information may be available regarding the impact on the environment when a good is used, for instance the emissions from a car when driven, there is no information available relating to the impact on the environment at other stages of the lifecycle of the good or service. For instance, when a good or service is created there is a quantifiable impact. When the good or service is disposed of there is another impact and so on.

Consequently, although a consumer may choose to purchase a car which has lower emissions than an equivalent alternative car, it may be that the chosen car has a greater impact on the environment due to its creation than the alternative. This could be due to the quantity and type of materials, together with the energy required and used in its creation. Alternatively, or additionally, the chosen car may have a greater impact on the environment when disposed of than the car with the lower emissions due to the presence of certain materials, for instance heavy metals.

### SUMMARY OF THE INVENTION

Certain aspects of this invention seek to alleviate at least some of these problems by providing methods and systems by which goods and services may be assessed to ascertain their environmental impact, the collected data stored in a database and made available for interrogation such that any entity, for instance a consumer, may not only compare the impact on the environment of one good with another but also so that the entity is able to inspect and analyse a record of the total impact of their consumption of goods and/or services in a pre-defined time period.

In a first aspect, the invention provides a method of collecting information relating to an environmental impact of a good and/or service, the good and/or service having a lifecycle from initial creation to final disposal, the method including a step of assessing the good and/or service at any pre-defined stage within the lifecycle to determine parameters relating to materials and/or processes used directly and indirectly to enable the good and/or service to reach the stage in the lifecycle.

In a second alternative aspect, the invention provides a method of storing information relating to an environmental impact of a good and/or service in a database, the good and/or service having a lifecycle from initial creation to final disposal, the information arising from an assessment of parameters relating to materials and/or processes used directly and indirectly to enable the good and/or service to reach any pre-defined stage in the lifecycle, the method including a step of storing the information in a database.

In a third alternative aspect, the invention provides a method of interrogating a database to obtain information relating to an environmental impact of a good and/or service, the good and/or service having a lifecycle from initial creation to final disposal, the information arising from an assessment of parameters relating to materials and/or processes used directly and indirectly to enable the good and/or service to reach any pre-defined stage in the lifecycle, the method including a step of requesting information from the database, the request including request criteria for limiting the requested information, and receiving the information in a report.

In a fourth alternative aspect, the invention provides a computer network implemented method for providing information relating to an environmental impact of a good and/or service, the good and/or service having a lifecycle from initial creation to final disposal, the method comprising steps of; assessing the good and/or service at any pre-defined stage within the lifecycle to determine parameters relating to materials and/or processes used directly and indirectly to enable the good and/or service to reach the stage in the lifecycle, collecting information from the assessment, sending the information to, and storing the information in, a database; and sending a request to the database with pre-defined criteria to retrieve the information.

In a fifth alternative aspect, the invention provides a system for providing information relating to an environmental impact of a good and/or service, the good and/or service having a lifecycle from initial creation to final disposal, the system comprising; a database for storing information concerning parameters relating to materials and/or processes used directly and indirectly to enable the good and/or service to reach the stage in the lifecycle; communication means for communicating electronically with the database by which any entity involved in the lifecycle of the good and/or service may retrieve data from, and add data to, the database; and interrogation means for interrogating the database.

In the various aspects and embodiments described herein, the term “parameters” may also be known in the technical field as “externalities”. Furthermore, the terms “environmental impact” and “parameters relating to materials and/or processes used directly and indirectly to enable the good and/or service to reach the stage in the lifecycle” may relate to the types and quantities of materials which may be used in the creation, further processing, use and disposal of any good and/or service. These materials may be identified by individual chemical compounds, for example water, carbon dioxide, etc., and elements such as gold or silver. Accordingly, any good and/or service may be identified by the types and quantities of all the chemical compounds and elements used directly and indirectly to enable it to reach a particular stage in their lifecycle. Further, the use, or conversion of energy may also be included for the assessment of the environmental impact of the goods and/or services. The parameters of goods and services may be defined in other ways such as by the so-called “ecological footprint” which may be measured in terms of the yield from a global hectare of land, electromagnetic radiation and thermodynamic energy.

The lifecycle of the good and/or service may comprise at least one of creating, packaging, transporting, storing, selling, using, consuming and disposing of the good and/or service. Other characteristics may also be included without limitation.

In the assessment of a good the constituent chemical compounds and elements of the good itself may be assessed together with the chemical compounds, elements and energy used directly and indirectly in its creation. The chemical compounds, elements and energy used in its creation but not forming part of the product itself may include such elements arising from the winning of raw materials, the processing of these raw materials, and the storage, transportation and sale by the manufacturer of the good. For instance, in the manufacture of paper, not only may the chemical compounds and elements present in the paper be assessed but also all other activates related to the manufacture may be assessed. For example, any fertilisers used in the growing of trees, the equipment used for the harvesting of the trees, and the energy required to process the trees may all need to be included in the assessment such that the final paper product may have associated with it a list of the types and quantities of all of the chemical compounds, elements and energy present and used in its manufacture. Any waste activities may also be assessed and categorised into waste to air, land or water such that the types of all chemical compounds and elements delivered to each of these three possibilities is quantified. The manufacturer of the paper may deliver this information to a database where it may be used by other parties during the lifecycle of the paper.

The absorption of carbon dioxide by the trees as they grow may also be taken account of in the assessment and will be accorded weight and value in a manner and method recognizable by those of skill in the art having considered the present disclosure.

The methods and system allow for any entity which takes ownership of the good and/or service to add data to the database relating to the types and quantities of all of the chemical compounds, elements and energy used directly and indirectly while owning that good and/or service. For instance, using the example of paper, if the paper were then transported to a printing company the type and quantity of the chemical compounds, elements and energy used in the transportation of the paper may be assessed together with the type and quantity of the chemical compounds, elements and energy used in printing the paper. Further still, the storage and subsequent transportation of the printed paper may also be assessed. Each time the ownership of the good and/or service changes information relating to the types and quantities of all of the chemical compounds, elements and energy used directly and indirectly in selling that good and/or service is sent to the database. The information sent may be cumulative in that an entity involved in selling a good and/or service may include in the information sent to the database all of the chemical compounds, elements and energy used directly and indirectly including those from earlier stages in the good and/or service lifecycle with which the entity may not have been involved. For instance, the printing company may include information relating to all of the chemical compounds, elements and energy used directly and indirectly in manufacturing the paper even if they were not involved in that activity.

Those of skill in the art will recognize that as used herein, the term “ownership” is to be broadly interpreted and is not limited to one in which remuneration in exchange for a particular good and/or service has to have occurred and therefore this term includes gifts or any other type of remuneration within the scope of the present invention; for example, by means merely of physical possession, following payment of money, or payment in kind, by the transfer of ownership by intangible means, and so on.

The database may hold information relating to the chemical compounds, elements and energy used directly and indirectly to enable any particular good and/or service to reach any particularly defined stage in its lifecycle.

The invention contemplates that data relating to the chemical compounds, elements and energy associated with all consumable materials used in the lifecycle of said good and/or service are added to the database. For instance, fuel and oil would be considered as consumable items in the example of paper manufacture.

Each entity involved in any stage of the lifecycle of the good and/or service may interrogate the database to extract data relating to the good and/or service of which they have taken possession. They may then also extract information from the database relating to any defined consumable items which they use and which can be directly and indirectly attributed to the particular good and/or service. For instance, in the example of paper manufacture, the fuel and oil manufacturers would supply data to the database relating to those products such that the paper manufacturer may then extract it for use in the assessment of the total types and quantities of chemical compounds, elements and energy used in their activities.

Accordingly, the methods may further comprise the step of, extracting from the database data relating to an earlier stage of the lifecycle of said good and/or service; collecting data relating to the materials and energy, whether consumable or otherwise, used directly and indirectly in the further processing of said good and/or service; and delivering to said database data relating to the quantities and types of all chemical compounds, elements and energy used in a subsequent stage of the lifecycle of said good and/or service.

The methods may further allow for at least some of said data relating to the materials and energy used in the further processing of said good and/or service, to be extracted from the database.

The methods may further comprise the step of providing a product unique reference for identifying in the database said good and/or service at each stage in its lifecycle. Each stage may be pre-defined. For example, the paper produced by the paper manufacturer in the above example, may be allocated a reference number to that paper. This reference may be allocated by the manufacturer. When the paper has been further processed, perhaps by having print applied, the printed paper is allocated a new unique reference so as to distinguish it within the database from the paper in the initial stage of its lifecycle and from all other printed paper which may be identified in the database and have differing types and quantities of chemical compounds, elements and energy associated with its lifecycle.

Not only are goods and/or services identified in the database by unique references but also all entities which are involved in the various stages of the lifecycle of the goods and/or services are identified by a unique reference. For example, the paper manufacturer will have one reference, the transportation company another, the printing company a third, and all “end users”, such as the general public will have consumer unique references. Accordingly, the methods contemplate the further step of providing a consumer unique reference for identifying any entity in the database.

The methods may also include the further step of including in said information sent to the database the identity of any entity which subsequently takes ownership of said good and/or service. For instance, the method includes the step of sending product and consumer unique references to the database when any entity takes ownership of said good and/or service.

The methods may include the step of sending data identifying the entity to the database substantially simultaneously with the taking of ownership of said good and/or service. For instance, the step of sending said unique references to the said database may occur at the time and/or place of purchase or receipt of the said good and/or service. This may occur at the point of sale in a store. However, the methods also contemplate the possibility that the transmission of this data occurs at a different time and/or place, for instance only after the new owner takes physical possession of the good and/or service.

The database may include unique references identifying said good and/or service at various stages of its lifecycle and unique references identifying entities which own said good and/or service at said various stages of its lifecycle. The methods may include sending request criteria which includes a unique reference identifying a said entity. The request criteria may include a defined time-period so that the report from the database includes a cumulative environmental impact of all said goods and/or services which the identified entity owns or has owned in the defined time-period.

The interrogation may be conducted via electronic communication means, such as telephone wires, modems, servers etc., as found in a typical computer network.

The database may include pre-defined time-based allowances, for individual entities such as end-users, of said types and quantities of chemical compounds, elements and energy used directly and indirectly to enable said good and/or service to reach said stage in said lifecycle. These allowances may be sent to the database and the methods may include this step.

The pre-defined allowances may be set by a recognised independent entity such as a non-governmental organisation, or by a government or by an international agreement. Other ways in which the allowances may be set are contemplated.

The methods may include the step of sending with the request criteria a request for said report to include an indication of the proportion of the actual types and quantity of identified chemical compounds, elements and energy, related to said goods and/or services for which an identified entity has taken ownership in a pre-defined time period, compared to said pre-defined allowance.

The report may then provide information which an entity may subsequently use to influence their sourcing of goods and/or services so as to stay within their allowances.

In addition to the database the system may include servers, modems, telephone wires and other electronic data links, for the transmission of data between the various entities having access to the database. Further, unique reference reading means such as bar-code scanners and magnetic strip readers, computer terminals and various peripheral devices, may be included in the system. Some of these communication means may be provided at the point of sale of the goods and/or services.

The system may include identifying means for uniquely identifying in the database individual entities, goods and/or services, associating means for associating uniquely identified goods and/or services to individual entities, and analysis means for analysing said information in said database to provide quantitative information relating to the types and quantities of chemical compounds, elements and energy associated with a pre-defined entity in a pre-defined time period.

In another aspect, the invention provides a method of collecting information relating to the nutritional value of a good, the method including the steps of assessing said good to determine the types and quantities of various substances in said good.

In yet another aspect, the invention provides a method of storing information relating to the nutritional value of a good in a database, the information arising from an assessment of said good to determine the types and quantities of various substances in said good, the method including the step of storing said information in a database.

In a further aspect, the invention provides a method of interrogating a database to obtain information relating to the nutritional value of a good in a database, the information arising from an assessment of said good to determine the types and quantities of various substances in said good, said method including the step of requesting information from said database, the request including parameters defining the criteria for the requested information, and receiving said information in a report.

In a yet further aspect, the invention provides a computer network implemented method for providing information relating to the nutritional value of a good in a database, the method comprising the step of assessing said good to determine the types and quantities of various substances in said good, collecting the information from the said assessment, sending said information to, and storing said information in, a database; and sending a request to said database with pre-defined parameters to retrieve said information.

In a different aspect, the invention provides a system for providing information relating to the nutritional value of a good in a database, the information arising from an assessment of said good to determine the types and quantities of various substances in said good; the system comprising a database for storing said information, communication means for communicating electronically with said database by which a supplier and/or consumer of said good may retrieve data from, and add data to, said database; and interrogation means for interrogating said database.

The above discussion of the various methods and systems regarding information relating to the environmental impact of goods and/or services is applicable, amended as necessary, to the various methods and systems regarding information relating to the nutritional value of goods.

The various substances in the said good may comprise vitamins and/or minerals and/or may include one or more of the following; saturates, monosaturates, polyunsaturates, transfats, cholesterol, fibre, gluten, salt, sodium, potassium, various vitamins such as vitamin A, B6, C, D or E, folic acid, various elements such as calcium, iron, phosphorous etc.

Following these methods and using the system it may be possible for a consumer to identify the nutritional value of the food they have purchased and/or consumed within a pre-defined period. This may be useful for the purposes of providing information relating to the consumption of goods and for analysing diet from the perspective of health issues.

The above, and other objects, features and advantages of the present invention will become apparent from the following detailed description read in conjunction with the accompanying drawings, in which like reference numerals designate the same elements.

The present invention and its advantages will be better understood by referring, by way of example, to the following detailed description and the attached figures.

### BRIEF DESCRIPTION OF THE DRAWINGS

FIG. 1 is a block diagram that illustrates a system for collecting, storing and distributing information relating to goods and/or services;

FIG. 2 is an alternative block diagram that illustrates a system for collecting, storing and distributing information relating to goods and/or services;

FIG. 3 is an example of a table of data relating to the environmental impact of a particular product;

FIG. 4 depicts a typical report comprising data and information that can be provided by the arrangements shown in FIGS. 1 and 2; and

FIG. 5 is an example of a table of data relating to the nutritional value of a particular product.

### DETAILED DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “transfer,” and similar terms with their inflectional morphemes do not necessarily denote direct and immediate connections or transmissions, but also include connections through mediate elements or devices or transmissions over any medium of transmission.

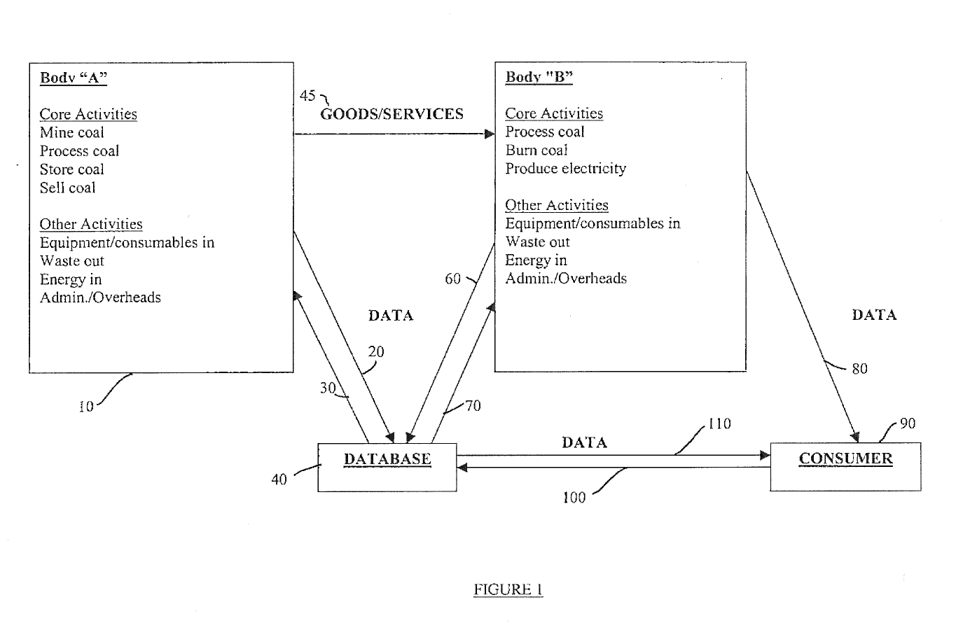

FIG. 1 depicts a system for collecting, storing and distributing information relating to the environmental impact of goods and/or services. In the arrangement shown in FIG. 1, Entity “A” 10 has the core activities of mining, processing, storing and selling coal. It also has other activities such as the buying in and using of equipment and consumables, the disposing of waste, the using of energy, and administration and overheads.

All of the goods and services of the activities undertaken by Entity “A” 10 whether they be core activities or other activities are analysed such that the type and quantity of all chemical compounds, elements and energy present inherently in each good and service and used both directly and indirectly in the production of each good and service is determined. This information is delivered to the central database 40 via communication means 20. Such communication means 20 may be by electronic transfer over the existing telephone network or via dedicated connections whether wireless or otherwise.

In assessing and determining the type and quantity of the chemical compounds, elements and energy used by Entity “A”, some of the information or data may already be present in the database 40, having been delivered by the supplier of that particular good and/or service. In this case, the information or data may be obtained from the database 40 and sent to Entity “A” 10 via communication means 30. If that information is not yet available from the database 40 then Entity “A” will be responsible for obtaining it. This assessment may be out-sourced to a separate entity or may be carried out in-house.

When Entity “A” 10 sells, or transfers ownership by any other means, goods and/or services 45 then the quantity and type of all the chemical compounds, elements and energy used in the goods and/or services 45 is sent to the database 40. Further, the identity of the new owner of the goods and/or services 45 is also sent to the database 40. Accordingly, the new owner of the goods and/or services 45, for example Entity “B” 50 is able to interrogate the database 40 via communication means 70 and see that they possess a certain quantity of goods and/or services 45 which are defined by a quantity and type of chemical compounds, elements and energy.

The new owner of the goods and/or services 45 may further process them. In FIG. 1, Entity “B” 50 takes possession of goods and/or services 45 from Entity “A” 10. In this example, Entity “B” 50 is a power generation company which burns coal to produce electricity. These are its core activities. However, it also has other activities such as the buying in and using of equipment and consumables, disposing of waste, the use of energy and administration and overheads. All of these activities are assessed again from the point of view of determining the quantity and type of all chemical compounds, elements and energy used both directly and indirectly in the further processing of the goods. This information is sent to the database 40 via communication means 60.

In the example in FIG. 1, the product produced by Entity “B” 50 is electricity 80. This electricity is sold to consumers 90 by conventional means such as via cables and overhead wires. Entity “B” 50 delivers data to the database 40 via communication means 60 relating to the quantity of electricity 80 sold to each consumer 90 in a given time period. The data also includes the identification of each and every consumer 90. Since the database 40 already includes the quantity and type of all chemical compounds, elements and energy used in the production of the electricity 80 the information which needs to be sent to the database 40 is the identity of the consumer 90 together with the quantity of electricity 80.

At any time, the consumer 90 may interrogate the database 40 via communication means 110 to assess the total type and quantity of all chemical compounds, elements and energy transferred into their ownership over a particular time period. The consumer 90 may identify itself to the database 40 via communication means 100.

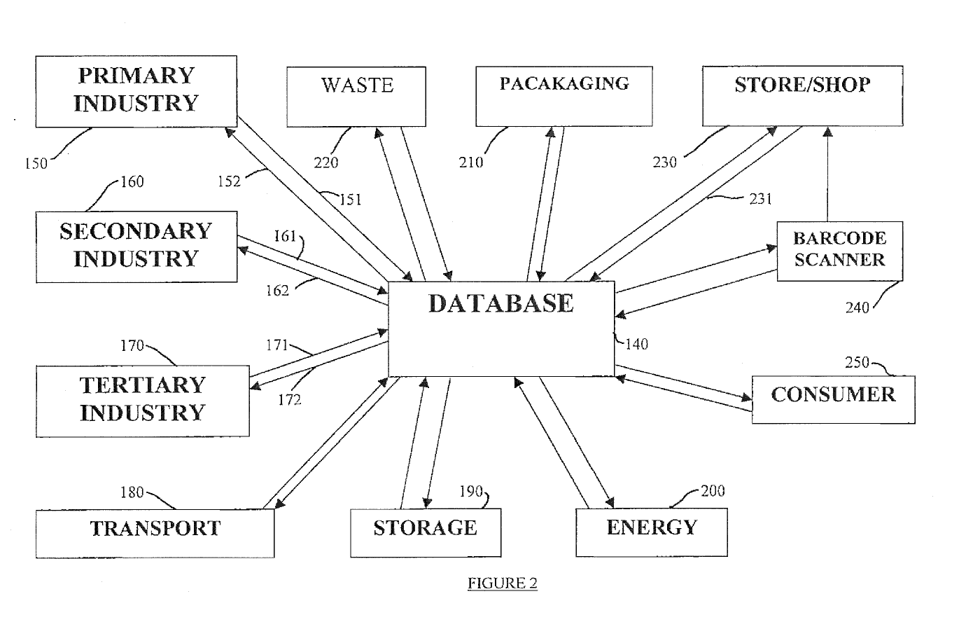

FIG. 2 is an alternative depiction of a system for providing information relating to the environmental impact of goods and/or services in accordance with the invention. In the arrangement shown in FIG. 2, a database 140 is shown in communication with various data providers. One such data provider is a primary industry 150. This may be a farm, a mine, or a fishery, for example. Another type of data provider is a secondary industry 160. This may be, for instance, an electricity producer or a steel producer.

An example of a tertiary industry 170 may be a canning plant which cans fish caught by the primary industry in cans made from steel by the secondary industry 160.

Each industry 150, 160, 170 is in communication with the database 140 via communication means 151, 152, 161, 162, 171, and 172.

Other types of data provider are indicated in FIG. 2. Some of these data providers may be independent companies such as the energy company 200 or the waste management company 220. Elements of these types of data will also be provided by the primary, secondary and tertiary industries, 150, 160, 170. For instance, when the primary industry 150 sells its goods to the secondary industry 160 they will use transport 180, storage 190, packaging 210 and energy 200. However, if this activity of transportation of the goods from the primary industry 150 to the secondary industry 160 is not undertaken by the primary industry 150 itself, such that ownership of the goods and/or services passes from the primary industry 150 to the transport company 180 before being passed to the secondary industry 160, then the intermediary entity/entities, such as the transportation company 180, are responsible for providing data to the database 140 relating to their activities.

The data which is delivered to the database 140 relates to the type and quantity of the chemical compounds, elements and energy used directly and indirectly in relation to the goods and/or services during the intermediary stage(s). For instance, if the transportation company 180 is independent from the primary 150 and secondary 160 industries then they are providing a service, of transportation, which includes the buying in and use of vehicles, manpower, fuel and the use of overheads and administration which includes all sorts of goods and services. Accordingly, the transportation company 180 adds information to the database 140 relating to the quantity and type of all of the chemical compounds, elements and energy used in the transportation of those goods. This data is delivered to the database 140 accompanied by means for identifying that data with respect to the goods and/or services in question.

Accordingly, throughout the lifecycle of the goods and/or services data relating to each stage of that lifecycle is collected and delivered to the database such that when the goods and/or services finally reach the consumer 250, it is possible to identify the total quantities and types of all of the chemical compounds, elements and energy which have been used directly and indirectly in the creation and delivery of the goods and/or services to that consumer 250.

One way in which this may be arranged is that each good and/or service would be identified by a unique reference number, which may be in the form of a bar-code. When the consumer 250 buys a good in a store 230 then the bar-code scanner 240 will identify the good to the database via communication means 231. This bar-code may also be combined with traditional bar-codes which are used for stock control and pricing.

In some circumstances, the good and/or service would not end its life at the consumer 250. Rather, the consumer may dispose of certain goods and/or services after use. For instance, a consumer may dispose of an empty can via the refuse collection service. Accordingly, the life of that empty can will continue until it reaches its final resting place. For instance, if that can is to be disposed of in a landfill then it would commence another journey via local refuse collection services, and landfill operators.

In one embodiment, the invention includes the possibility of this further journey and further processing being assessed and the quantities and types of the chemical compounds, elements and energy used in these further stage(s) of the lifecycle of the good and/or service being delivered to the database. However, it is also possible that as far as the database is concerned, the information relating to the latter stages in the lifecycle of the good and/or service after it has been “consumed” has already been assessed and that information sent to the database. In other words, when a consumer buys a can of tuna in a store the data which is delivered to the database relates to all of the types and quantities of the chemical compounds, elements and energy used directly and indirectly in the lifecycle of the can of tuna not only up to the point where it is taken possession of by the consumer but also relating to the types and quantities of the chemical compound, elements and energy used directly and indirectly in the further processing of the can after it has been consumed based on certain assumptions. For instance, it could be assumed that the can of tuna would be opened, the tuna removed, and the can sent to landfill, or alternatively, be recycled.

It is also possible to identify and deliver data to the database relating to the final disposal of the good and/or service. This data could be identified as the type and quantity of chemical compounds and elements categorised by their final destination, for example to landfill, to atmosphere (in the case of incineration and evaporation, or to water (in the case of disposal into water courses or bodies of water such as lakes and seas).

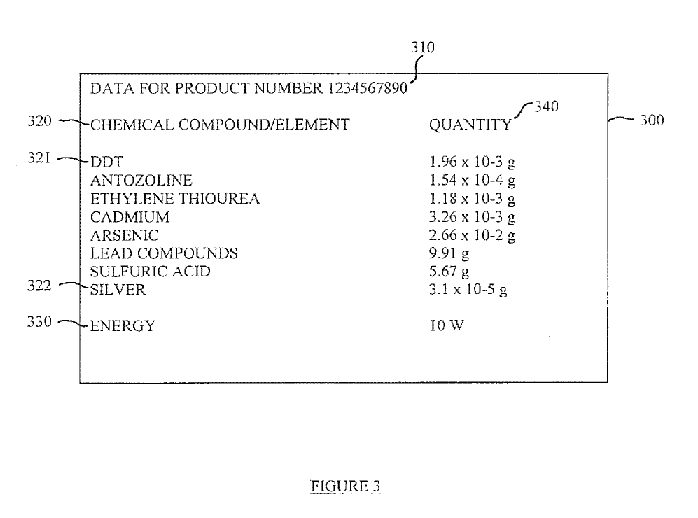

An example of the data collected and sent to the database is shown in FIG. 3. This data 300 comprises a product identification number 310 and two columns 320, 340. The first column 320 lists the chemical compounds and elements which have been identified as being relevant to the lifecycle of the good and/or service. The second column 340 lists the quantities of each of those chemical compounds. These quantities may relate to a unit of the product or by weight of the product. An example of a chemical compounds is DDT 321 and an example of an element is silver 322. At the bottom of the data sheet 300 the quantity of energy 330 is listed. This is the quantity of energy that has been used directly and indirectly in the lifecycle of the product, up to that point in time, identified by the identification number 310 at the top of the sheet 300.

This information is delivered to the database. Each time more information relating to that particular product identified by the identification number 310 is collected it is delivered to the database. For instance, if the product is created by one entity then that entity would deliver the information relating to the creation of that product to the database. If that product is then transported by another entity then information relating to the transportation of that product by that entity would be added to the database by that entity. In this way, all of the types and quantities of chemical compounds, elements and energy used directly and indirectly in the lifecycle of the good and/or service can be collected within the database.

If the good and/or service is further processed then the entity responsible for the further processing interrogates the database to retrieve the data relating to the raw materials identified within the database by their individual and unique references. Then the entity which is responsible for the further processing assesses the types and quantities of all of the chemical compounds, elements and energy used directly and indirectly in the further processing of that good and/or service and delivers this data to the database. This information includes the data relating to the raw material and the data relating to the further processing of the good and/or service and is identified by another unique reference.

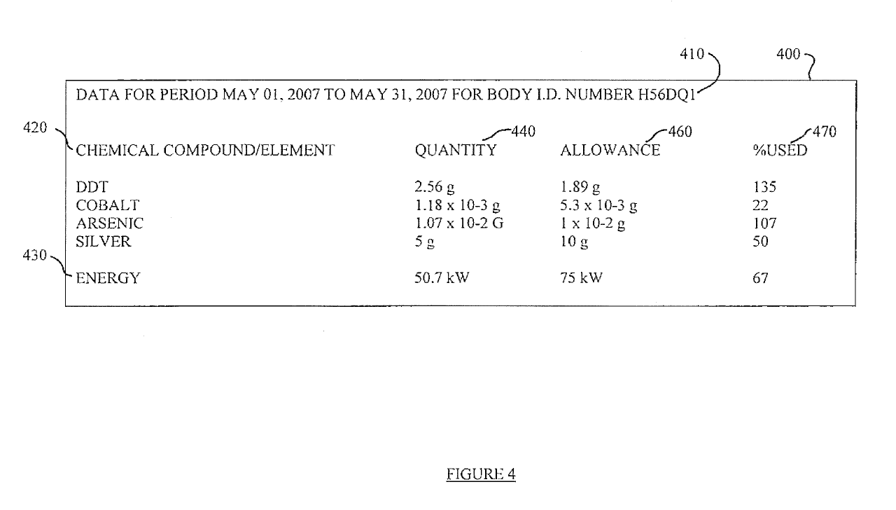

Any entity identified within the database may interrogate that database to review the data collected therein relating to themselves. For instance, a consumer may interrogate the database periodically and retrieve data relating to a particular time period. An example of this is shown in FIG. 4. This summary sheet 400 provides data for the period May 1, 2007 to May 31, 2007 for a particularly identified entity. In this case it is identified by an identification number referenced 410.

The summary sheet 400 has 4 columns 420, 440, 460, 470. The first column lists the chemical compounds and elements, the second column lists the quantities, the third column lists an allowance and the fourth column lists the percentage allowance that has been used within that period.

At the bottom of the sheet 400 the amount of energy consumed by the identified entity is listed. An allowance is also provided for this and the percentage of this allowance that has been used within that period is shown.

Although not shown, the sheet 400 may also include information relating to the quantity and type of chemical compounds and elements sent to variously defined disposal locations. An allowance for each location may be provided. The summary sheet 400 may therefore also provide an indication of the percentage of each consumer's allowance which has been used with regard to landfill, for example.

With regard to the third column 460, the allowances may be set by a locally, nationally, or internationally recognised organisation. These allowances may vary over time as greater understanding of the impacts of certain chemical compounds, elements and energy on the environment is developed.

Although FIG. 4 shows an example of data provided to a consumer, it should be understood that the term “consumer” does not necessarily define an end user such as a person buying a can of tuna in a store. Rather, it also includes any entity taking possession of a good and/or service during its lifecycle. For instance, the “consumer” could be a secondary industry which further processes the good received from the primary industry.

Further, the “consumption” of a good and/or service does not necessarily refer simply to the eating of a good. Rather, it also includes, although not exclusively, the buying, borrowing, hiring, owning, processing and using in any way, shape or form of the good and/or service.

Although the summary data shown in FIG. 4 is provided in a tabulated form, it may also be provided in other forms such as a graphical form.

It is also possible for the system to provide indications to particular entities that the total quantity of a particular chemical compound, element or energy is nearing the maximum set by their particular allowance. These indications could take the form of email alerts, alarm signals, etc. In this way, the system may provide guidance to a particular entity that they need to seek an alternative good and/or service which has a lower impact on the environment. In this way, consumers may be persuaded to adapt their purchasing habits to stay within the limit set by their personal allowances. This applies to commercial entities as well as private individuals.

The methods and systems can be adapted for use with nutritional information relating to the nutritional value of food such that a supplier of a particular product sends data relating to all of the types and quantities of various substances of which the product comprises. The various substances in the product may comprise protein, carbohydrates such as sugars and starch, vitamins and minerals and may include one or more of the following; saturates, monosaturates, polyunsaturates, transfats, cholesterol, fibre, gluten, salt, sodium, potassium, various vitamins such as vitamin A, B6, C, D or E, folic acid, various elements such as calcium, iron, phosphorous etc. The quantity of energy derivable from the food may also be included in the nutritional value.

Each product is identified to the database by a unique reference. When a consumer buys, or takes possession, of any product then that reference is allocated to their own identification reference within the database such that at any time a consumer may interrogate the database and analyse the information held within it relating to the nutritional value of their purchases.

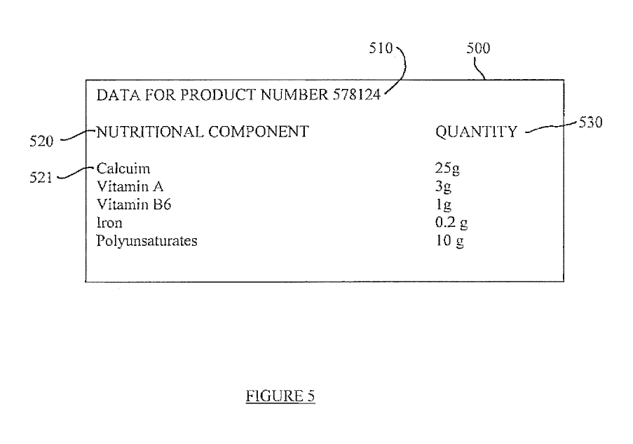

An example of a report 500 showing the nutritional information relating to a product is shown in FIG. 5. The product is identified by a unique reference number 510. The first column 520 lists the various substances such as calcium. The second column 530 lists the quantities of each substance.

Reports indicating the total quantities and types of substances in a defined period are also available from the database providing summary information in a similar to that shown in FIG. 4 with regard to the chemical compounds, elements and energy discussed above.

Those of skill in the art should recognize that the use of the phrase “at least one aspect of a good and a service” and a “good and/or services” will be recognized as substantial equivalents wherein the term “aspect” is used descriptively to refer to either a good or a service or both or a portion of either.

Those of skill in the art will also recognize that the use of the phrase “facet” when used in relation herein to materials and processes used directly or indirectly to enable goods and/or services is used descriptively to refer to either a material or a process/service or both or a portion of either to enable the collection and consideration of information.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of collecting information relating to an environmental impact of at least one aspect of one of a good and a service, said at least one aspect having a lifecycle from an initial creation to a final disposal, said method comprising the steps of:
assessing said at least one aspect at a pre-defined stage within said lifecycle to determine at least one of a plurality of parameters relating to at least one facet of one of a material and a processes used to enable said at least one aspect of said good and said service to reach said pre-defined stage in said lifecycle.

2. A method of collecting according to claim 1, wherein:
said at least one of said plurality of parameters relating to said at least one facet further comprises:
at least one of a type of a chemical compound, a quantity of a chemical compound, an energy that is present in said at least one facet of said at least one of said material and said process, an energy that is used in said at least one facet of said at least one of said material and said process, an element that is present in said at least one facet of said at least one of said material and said process; and an element that is used in said at least one face of said at least one of said material and said process.

3. A method of collecting according to claim 1, wherein:
said lifecycle of said at least one aspect of said at least one of said good and said service further comprises:
at least one of a creating, a processing, a packaging, a transporting, a storing, a selling, a using, a consuming, and a disposing of said at least one aspect of said at least one of said good and said service.

4. A method of collecting according to claim 1, wherein:
said step of assessing further comprises the step of:
conducting an assessment of all consumable materials used directly and indirectly to enable said at least one aspect of said one of said good and said service to reach said pre-defined stage in said lifecycle.

5. A method of storing information relating to an environmental impact of at least one aspect of one of a good and a service in a database, said at least one aspect having a lifecycle from an initial creation to a final disposal, said information arising from a method comprising the steps of:
assessing at least one of a plurality of parameters relating to said at least one facet of one of a material and a processes;
said one of said material and said process being used to enable said at least one aspect of said one of said good and said service to reach a pre-defined stage in said lifecycle, and said method further comprising the step of:
storing said information in a database.

6. A method of storing information, according to claim 5, wherein:
said at least one of said plurality of parameters relating to said at least one facet further comprises:
at least one of a type of a chemical compound, a quantity of a chemical compound, an energy that is present in said at least one facet of said at least one of said material and said process, an energy that is used in said at least one facet of said at least one of said material and said process, an element that is present in said at least one facet of said at least one of said material and said process; and an element that is used in said at least one face of said at least one of said material and said process.

7. A method for storing information, according to claim 5, wherein:
said lifecycle of said at least one aspect of said at least one of said good and said service further comprises:
at least one of a creating, a processing, a packaging, a transporting, a storing, a selling, a using, a consuming, and a disposing of said at least one aspect of said at least one of said good and said service.

8. A method for storing information, according to claim 5, wherein:
said step of assessing further comprises the step of:
conducting an assessment of all consumable materials used directly and indirectly to enable said at least one aspect of said one of said good and said service to reach said pre-defined stage in said lifecycle.

9. A method for storing information, according to claim 5, further comprising the step of:
electronically sending said information to said database.

10. A method for storing information, according to claim 9, further comprising a step of:
including in said information a unique reference for identifying in said database said at least one aspect of said one of said good and said service at any said pre-defined stage in said lifecycle.

11. A method for storing information, according to claim 5, further comprising a step of:
including in said information a unique reference for identifying an entity which owns said at least one aspect of said one of said good and said service.

12. A method for storing information, according to claim 11, further comprising a step of:
including in said information a unique reference identifying an entity which subsequently takes an ownership of said at least one aspect of said one of said good and said service.

13. A method for storing information, according to claim 11, wherein:
said step of electronically sending said information identifying said entity occurring substantially simultaneously with a transfer of ownership of said one of said good and said service.

14. A method of interrogating a database to obtain information relating to an environmental impact of at least one aspect of one of a good and a service, said at least one aspect of said good and said service having a lifecycle from an initial creation to a final disposal, said information arising from an assessment of one of a plurality of parameters relating to at least one facet of a material and a process used to enable said one of said good and said service to reach any pre-defined stage in said lifecycle, said method comprising the steps of:
requesting said information from said database,
said step of requesting including at least one request criteria for limiting said requested information; and
receiving said information in a report.

15. A method of interrogating a database, according to claim 14, wherein:
said at least one of said plurality of parameters relating to said at least one facet further comprises:
at least one of a type of a chemical compound, a quantity of a chemical compound, an energy that is present in said at least one facet of said at least one of said material and said process, an energy that is used in said at least one facet of said at least one of said material and said process, an element that is present in said at least one facet of said at least one of said material and said process; and an element that is used in said at least one face of said at least one of said material and said process.

16. A method of interrogating a database, according to claim 14, wherein:
said database further comprises:
at least one unique reference identifying said at least one aspect of said one of said good and said service at least one designated stages of its lifecycle;
said at least one unique reference further identifying at least one entity which owns said at least one aspect of said one of said good and said service at said at least one designated state of said lifecycle, and
said request criteria further comprises:
at least one unique reference identifying said at least one entity for limiting said requested information to said at least one entity.

17. A method of interrogating a database, according to claim 16, wherein:
said request criteria further comprises:
a time-period so that said report includes a cumulative environmental impact of all of said aspects of said at least one of said good and said service which said identified entity owns in said time-period.

18. A method of interrogating a database, according to claim 15, wherein said database further comprises:
a plurality of unique references identifying said at least one of said good and said service at designated stages of its lifecycle;
said unique references identifying entities which own said at least one aspect of said one of said good and said service at said designated stages of said lifecycle; and further comprises the steps of:
using a pre-defined time-based allowances of said parameters to enable said at least one aspect of said one of said good and said service to reach said designated stages in said lifecycle, and
sending in said request criteria a request for said report to include an indication of at least one of a proportion of one of an actual type and a quantity of identified chemical compounds, an energy related to said at least one of said good and said service, an element related to said at least one of said good and said service; wherein said indication is further related to said at least one of said good and said service for which said identified entity has taken an ownership in a pre-defined time period compared to said pre-defined allowance.

19. A computer network implemented method for providing information relating to an environmental impact of at least one aspect of one of a good and a service, said at least one of said good and said service having a lifecycle from an initial creation to a final disposal, said method comprising steps of:
assessing said at least one aspect of said one of said good and said service at a pre-defined stage within said lifecycle to determine at least one of a plurality of parameters relating to at least one facet of at least one of a material and a process used to enable said at least one of said good and said service to reach a stage in said lifecycle;
collecting information from following a completion of said step of accessing;
sending said information to a database;
storing said information in a database; and
sending a request to said database with pre-defined criteria to retrieve said information.

20. A computer network implemented method, according to claim 19, wherein:
said plurality of parameters includes at least one of a type of a chemical compound, a quantity of a chemical compound, an element involved with said at least one facet of said at least one of said material and said process, an energy that is present in said at least one facet; and an element is used in said at least one facet of said material and said process.

21. A system for providing information relating to an environmental impact of at least one aspect of one of a good and a service, said at least one of said good and said service having a lifecycle from an initial creation to a final disposal, the system comprising:
a database for storing information concerning at least one of a plurality of parameters relating at least one facet of a material and a process; said at least one facet enabling said at least one aspect of said one of said good and said service to reach a stage in said lifecycle;
communication means for communicating electronically with said database by which any entity involved in said lifecycle of said at least one of said one of said good and said service may retrieve data from, and add data to, said database;
and interrogation means for interrogating said database.

22. A system for providing information, according to claim 21, wherein:
said at least one of said plurality of parameters relating to said at least one facet further comprises:
at least one of a type of a chemical compound, a quantity of a chemical compound, an energy that is present in said at least one facet of said at least one of said material and said process, an energy that is used in said at least one facet of said at least one of said material and said process, an element that is present in said at least one facet of said at least one of said material and said process; and an element that is used in said at least one face of said at least one of said material and said process.

23. A system for providing information, according to claim 21, wherein:
said communication means are provided at a point of sale of said at least one aspect of said at least one of said good and said service.

24. A system for providing information, according to claim 22, further comprising:
identifying means for uniquely identifying in said database at least one of an individual entity, said at least one of said good and said service, an associating means for associating uniquely identified ones of said goods and said services to individual entities, and an analysis means for analysing said information in said database to provide a quantitative information relating to said types and said quantities of said at least one of said chemical compounds, said elements, and said energy associated with a pre-defined entity in a pre-defined time period.
